(19) United States
(12) Patent Application Publication
(10) Pub. No.: US 2025/0112793 A1
(43) Pub. Date: Apr. 3, 2025

(54) AN APPARATUS

(71) Applicant: DUALITY QUANTUM PHOTONICS LTD, Bristol (GB)

(72) Inventors: Anthony LAING, Bristol (GB); Alberto POLITI, Bristol (GB); Dara Patrick Stephen MCCUTCHEON, Bristol (GB); Lawrence Mark ROSENFELD, Bristol (GB)

(21) Appl. No.: 18/833,167

(22) PCT Filed: Feb. 1, 2023
(86) PCT No.: PCT/EP2023/052467

§ 371 Date: Jul. 25, 2024

(30) Foreign Application Priority Data
Feb. 1, 2022 (GB) 2201275.1

(51) Int. Cl. H04L 9/32; G02B 6/26; G02B 6/293

(52) U.S. Cl. CPC H04L 9/3278; G02B 6/262; G02B 6/268; G02B 6/29332; G02B 6/2935

(57) ABSTRACT

An apparatus including a photonic physically unclonable function (PUF) device for processing an initial optical mode distribution based on a challenge C and outputting a final optical mode distribution, the photonic PUF device includes optical mode waveguides for forming or supporting optical modes to which the initial optical mode distribution is provided and from which the final optical mode distribution is produced. Optical mode mixing layers are spaced apart along, and coupled to, the optical mode waveguides to mix the optical modes received by each optical mode mixing layer so that the optical mode distribution leaving each optical mode mixing layer is different to the optical mode distribution received by each optical mode mixing layer. Columns of optical phase shifters spaced apart along, and coupled to, the optical mode waveguides for applying pre-determined optical phase shift(s) to change the respective phases of the optical modes prior to the optical modes being received by a respective optical mode mixing layer. In examples, for two, or more, or each, of the columns of optical phase shifters, the optical phase shifters are coupled to each one of the optical mode waveguides. A security controller for controlling the photonic PUF device and receiving the challenge C and providing a response R. The security controller translates the challenge C and provides the translated challenge C to the photonic PUF device, and the security controller receives and translates a final optical mode distribution output by the photonic PUF device into the response R. A computer readable storage medium including instructions for a processor to issue a challenge C to the security controller, and receive a response R from the security controller.

This application claims priority from earlier application number GB2201275.1 filed Feb. 1, 2022, the contents and elements of which are herein incorporated by reference for all purposes.

### FIELD

The present invention relates to a physically unclonable function (PUF) and an apparatus incorporating a physically unclonable function (PUF).

### BACKGROUND

PUFs are devices or processes which are used in applications that require authentication to provide improved security against unauthorised access or interference. For example, authentication processes between mobile devices and/or servers to authenticate the identity of the mobile devices/servers. PUFs are distinguished in their ability to be unclonable, that is, it is practically impossible to recreate the device or process which provides the PUF.

The use of a PUF is characterised by so-called challenge (C) and response (R) pairs (CRPs) whereby the PUF is interrogated by a challenge C, to which the PUF outputs a response R. The manufacturer of the PUF would typically collate a large set of CRPs for each PUF. The PUF is then given to a third party. If the manufacturer, or a second party with access to the set of CRPs, wishes to authenticate the identity of the third party, the third party is requested to interrogate the PUF with a specific challenge C, and to communicate a response R′ from the PUF to the manufacturer/second party. If R′ corresponds to the correct R in the manufacturer/second party's possession, then the third party has been successfully authenticated.

The example described is in the context of a network application but PUFs can be used in a number of different applications, e.g., within a single device or computer processor chip, or for use in generating cryptographic keys.

A PUF can be understood as an object that provides a physically-defined unique identifier or fingerprint when the PUF is interrogated.

PUFs have been realised by, for example, relying on the power-on state of battery powered static random-access memory (SRAM). This state, due to inherent manufacturing variability beyond the manufacturer's control, is in the form of a random string of logical bits corresponding to each SRAM cell. The corresponding fingerprint is determined by the physical characteristics of the device itself and is not defined by the manufacturer or user; albeit the PUF has only a single CRP, i.e., the power-on state of the SRAM cells. PUFs have been realised in varied forms and technology platforms.

The basic properties of a PUF can be summarised to include:
a) the PUF, when challenged, must provide a response that (with high probability) is unique to that PUF.
b) The function that maps the challenge to the response depends on inherent and practically unclonable physical characteristics of the PUF.
c) One cannot create or approximate the function accurately solely from knowledge of the manufacturing process used to manufacture the PUF.

PUFs can be further characterised by reference to their relative robustness into weak and strong PUFs. A weak PUF is one for which the number of CRPs is small enough that an untrusted party could intercept or otherwise record all possible CRPs, e.g., in the case of the SRAM cell, the untrusted party could record the single CRP and later impersonate the intended party thereby foiling the authentication process. A strong PUF is one for which there are an exponentially large (exponential in physical resources such as number of modes) number of possible CRPs, or at least so large that it is practically impossible to sample a sufficiently large subset in order for an untrusted party to know the response to a randomly issued challenge and to then foil the authentication process. It is noted that this requirement also arises because the authentication process can only be continued securely if the number of CRPs recorded by the manufacturer/first party, prior to the PUF being sent to a second party/remote party, has not been exhausted.

The present invention seeks to provide an improved PUF and apparatus incorporating the same.

### BRIEF DESCRIPTION OF THE INVENTION

According to an aspect of the invention we provide an apparatus including:
a photonic physically unclonable function (PUF) device for processing an initial optical mode distribution based on a challenge C and outputting a final optical mode distribution, the photonic PUF device including:
optical modes (e.g., optical mode waveguides for forming or supporting optical modes (Mᵢ)) to which the initial optical mode distribution is provided and from which the final optical mode distribution is produced:
optical mode mixing layers (Kⱼ) spaced apart along, and coupled to, the optical modes (e.g., optical mode waveguides for forming or supporting optical modes (Mᵢ)) to mix the optical modes (Mᵢ) received by each optical mode mixing layer (Kⱼ) so that the optical mode distribution leaving each optical mode mixing layer (Kⱼ) is different to the optical mode distribution received by each optical mode mixing layer (Kⱼ);
columns (Sₖ) of optical phase shifters spaced apart along, and coupled to, the optical modes (e.g., optical mode waveguides for forming or supporting optical modes (Mᵢ)) for applying pre-determined optical phase shift(s) to change the respective phases of the optical modes (Mᵢ) prior to the optical modes being received by a respective optical mode mixing layer (Kⱼ), wherein, for two, or more, or each, of the columns (Sₖ) of optical phase shifters, the optical phase shifters are coupled to each one of the optical modes (e.g., optical mode waveguides for forming or supporting optical modes (Mᵢ));
a security controller for controlling the photonic PUF device and receiving the challenge C and providing a response R, wherein the security controller translates the challenge C and provides the translated challenge C to the photonic PUF device, and the security controller receives and translates a final optical mode distribution output by the photonic PUF device into the response R;
a computer readable storage medium including instructions for a processor to:
issue a challenge C to the security controller; and
receive a response R from the security controller.

References herein to “mode” in the context of an “optical mode” may be considered to include a reference to a propagation mode of light. Modes may occur in free space, in a transparent homogeneous medium, in a waveguide structure, or in an optical resonator. When a light beam propagates, its transverse intensity profile generally changes during propagation. Certain electric field distributions of the wave may be self-consistent during propagation, and these are examples of what is known in the art as a propagation “mode”. The simplest kind of propagation mode is a plane wave. Waveguide structures are generally considered in the art to be spatially inhomogeneous structures which can guide waves. For light propagating in an optical waveguide, a self-consistency of electric field distributions of the light wave forming a given mode may correspond to the shape of the electric field amplitude profile in the transverse dimensions remaining substantially constant at a given position in the waveguide. The modes of an optical wave may be defined by the properties of coherence and orthogonality: modes are orthogonal solutions of the electromagnetic wave equation describing the circumstances of the optical wave, which do not interfere (e.g., the optical power of a linear superposition of modes is equal to the sum the optical power of the individual modes). The light (photons) within one and the same mode may be coherent. Waveguides may support multimode light transmission whereby a plurality of different optical propagation modes occur simultaneously.

References herein to an “optical mode distribution” may be considered to include a reference to the distribution of light in and amongst optical modes. For example, two optical mode distributions may be considered to be different if they correspond to different distributions of amplitudes across the plurality of optical modes (e.g., in separate respective optical waveguides) of each distribution. In this sense, a first optical mode distribution may be considered to be “different” to a second optical mode distribution if, when distributed amongst the plurality of separate optical modes (e.g., separate waveguides), the first distribution of light (e.g., the amplitudes) differs from the second distribution of light (i.e., the amplitudes are distributed differently).

According to an aspect of the invention we provide an apparatus including:
a photonic physically unclonable function (PUF) device for processing an initial optical mode distribution based on a challenge C and outputting a final optical mode distribution, the photonic PUF device including:
optical modes (Mᵢ) (e.g., optical mode waveguides for forming or supporting optical modes (Mᵢ)) to which the initial optical mode distribution is provided and from which the final optical mode distribution is produced;
optical mode mixing layers (Kⱼ) spaced apart along, and coupled to, the optical modes (e.g., optical mode waveguides for forming or supporting optical modes (Mᵢ)) to mix the optical modes (Mᵢ) received by each optical mode mixing layer (Kⱼ) so that the optical mode distribution leaving each optical mode mixing layer (Kⱼ) is different to the optical mode distribution received by each optical mode mixing layer (Kⱼ), wherein one, or more, or each, of the optical mode mixing layers mixes (Kⱼ) more than two of the optical modes (Mᵢ);
columns (Sₖ) of optical phase shifters spaced apart along, and coupled to, the optical modes (e.g., optical mode waveguides for forming or supporting optical modes (Mᵢ)) for applying pre-determined optical phase shift(s) to change the respective phases of the optical modes (Mᵢ) prior to the optical modes being received by a respective optical mode mixing layer (Kⱼ);
a security controller for controlling the photonic PUF device and receiving the challenge C and providing a response R, wherein the security controller translates the challenge C and provides the translated challenge C to the photonic PUF device, and the security controller receives and translates a final optical mode distribution output by the photonic PUF device into the response R;
a computer readable storage medium including instructions for a processor to:
issue a challenge C to the security controller; and
receive a response R from the security controller.

Optionally or preferably, for two, or more, or each, of the columns (Sₖ) of optical phase shifters, the optical phase shifters are coupled to each one of the optical modes (Mᵢ) (e.g., optical mode waveguides), and/or wherein one, or more, or each, of the optical mode mixing layers (Kⱼ) mixes all of the optical modes (Mᵢ).

Optionally or preferably, the apparatus including a reconfigurable photonic network having an input (e.g., an input part) connectable to a single input optical mode (e.g., connectable to receive, support or form the single input optical mode), and output(s) (e.g., output parts) connectable to the optical modes (Mᵢ) (e.g., connectable to the optical mode waveguides), wherein the challenge C includes initial optical mode distribution information and the security controller uses the initial optical mode distribution information to cause the reconfigurable photonic circuit to adopt a corresponding configuration in order to generate the initial optical mode distribution.

Optionally or preferably, the reconfigurable photonic network includes optical phase shifters (Rₛ) for generating the initial optical mode distribution.

Optionally or preferably, the reconfigurable photonic network comprises an array of Mach-Zehnder interferometers for transforming light from the single input optical mode into a linear optical state corresponding to the initial optical mode distribution over the optical modes Mᵢ. The term “linear optical state” may be considered to include a reference to an optical state distributed across all required optical modes. Preferably, any desired initial optical mode distribution may be obtained by transforming one optical mode into all of the required optical modes.

Optionally or preferably, the challenge C includes information to determine the optical phase shifter settings, and the security controller uses this information that determines the optical phase shifter settings to set the columns (Sₖ) of optical phase shifters and/or, to set the optical phase shifters (Rₛ).

Optionally or preferably, the columns (Sₖ) of optical phase shifters and the optical mode mixing layers (Kⱼ) alternate along the length of the optical modes (Mᵢ).

Optionally or preferably, j=0 to K, and k=0 to K+1, (e.g., K is a positive integer) wherein the (K+1)^{th} column (S_{K+1}) of optical phase shifters is for applying an adjustment of the final optical mode distribution in the optical modes (Mᵢ) for subsequent use downstream in an interferometer process.

According to an aspect of the invention we provide a photonic physically unclonable function (PUF) device for processing an initial optical mode distribution based on a challenge C and outputting a final optical mode distribution, the photonic PUF device including:
optical modes (Mᵢ) (e.g., optical mode waveguides for forming or supporting optical modes (Mᵢ)) to which the initial optical mode distribution is provided and from which the final optical mode distribution is produced;
optical mode mixing layers (Kⱼ) spaced apart along, and coupled to, the optical modes (e.g., optical mode waveguides for forming or supporting optical modes (Mᵢ)) to mix the optical modes (Mᵢ) received by each optical mode mixing layer (Kⱼ) so that the optical mode distribution leaving each optical mode mixing layer (Kⱼ) is distributed differently to the optical mode distribution received by each optical mode mixing layer (Kⱼ), wherein each of the optical mode mixing layers (Kⱼ) include continuous evanescently coupled waveguides arranged to receive at least a subset of the optical modes (Mᵢ) to effect mixing of the respective amplitudes of the subset of the optical modes (Mᵢ);
columns of optical phase shifters (Sₖ) spaced apart along, and coupled to, the optical modes (e.g., optical mode waveguides for forming or supporting optical modes (Mᵢ)) for applying pre-determined optical phase shift(s) to change the respective phases of the optical modes prior to the optical modes being received by a respective mixing layer; and
a security controller for controlling the photonic PUF device and receiving the challenge C and providing a response R, wherein the
security controller translates the challenge C and provides the translated challenge C to the photonic PUF device, and the security controller receives and translates a final optical mode distribution output by the photonic PUF device into the response R; and
a computer readable storage medium including instructions for a processor to:
issue a challenge C to the security controller; and
receive a response R from the security controller.

Optionally or preferably, the optical modes (Mᵢ) are formed in respective waveguides (e.g., optical mode waveguides), and the continuous evanescently coupled waveguides correspond to regions of the waveguides.

Optionally or preferably, wherein each of the optical mode mixing layers (Kⱼ) include continuous evanescently coupled waveguides that receive at least a subset of the optical modes (Mᵢ) to effect mixing of the respective amplitudes of the subset of the Mᵢ optical modes, optionally or preferably the optical modes (Mᵢ) are formed in respective waveguides, and the continuous evanescently coupled waveguides correspond to regions of the waveguides. The subset of the optical modes (Mᵢ) may comprise at least three, or all, of the optical modes (Mᵢ).

Optionally or preferably, for the apparatus or photonic physically unclonable function (PUF) a separation between the evanescently coupled waveguides and/or length over which the evanescently coupled waveguides are proximate to one another is pre-determinedly formed so that the strength of evanescent coupling of the respective optical mode mixing layers (Kⱼ) is determined by a combination of the separation and length, and microscopic features of the waveguides that are not (e.g., cannot be) pre-determinedly formed during manufacture.

Optionally or preferably, for the apparatus or photonic physically unclonable function (PUF) one or more of the optical mode mixing layers (Kⱼ) include continuous evanescently coupled waveguides that receive at least three, or all, of the optical modes (Mᵢ) to effect mixing of the respective amplitudes of the at least three, or all, of the optical modes (Mᵢ). References herein to “at least three” in the context of at least three optical modes (Mᵢ), and/or of at least three evanescently coupled waveguides, may include, for example: four or more optical modes (Mᵢ), and/or four or more evanescently coupled waveguides; five or more optical modes (Mᵢ), and/or five or more evanescently coupled waveguides; ten or more optical modes (Mᵢ), and/or ten or more evanescently coupled waveguides. The evanescently coupled waveguides may implement the mixing of optical modes to provide a random walk of photons amongst/between the optical modes and/or amongst/between the evanescently coupled waveguides, as noted above, and this effect has been found to be significantly enhanced as the number of modes and/or waveguides involved in the mixing process increases above two. The total number “M” of the optical modes (Mᵢ) and/or waveguides involved in the mixing process, i.e., “all of them”, may be three or more e.g., M≥3, or M≥5, or M≥10.

Optionally or preferably, for the apparatus or photonic physically unclonable function (PUF) according to any preceding claim including a light source from which the initial optical mode distribution is created, wherein the light source may include a laser, e.g., an electrically pumped integrated laser, an LED source with a narrow light spectrum, or a quantum state of light, e.g., squeezed light or single photons.

Optionally or preferably, the apparatus or photonic physically unclonable function (PUF) includes an optical measurement device connected to the optical modes (Mᵢ) (e.g., connected to the optical mode waveguides) for measuring the final optical mode distribution.

Optionally or preferably, the optical measurement device includes photodiodes or single photon detectors.

Optionally or preferably, the photonic physically unclonable function (PUF) is an integrated photonic chip.

Optionally or preferably, the integrated photonic chip is formed from one or more of Silicon (Si), Silicon nitride (SiN), Silica (SiO₂), Gallium Arsenide (GaAs), Indium Phosphide (InP), Polymer, Lithium Niobate (LiNbO), or Aluminium Nitride (AlN).

Optionally or preferably, the apparatus or photonic physically unclonable function (PUF) including optical phase shifters that are independently controllable and/or may include thermo-optic, electro-optic, piezo-electric, birefringent, micro-electro-mechanical, strain-inducing, or acousto-optic devices.

According to an aspect of the present invention we provide a photonic physically unclonable function (PUF) device for processing an initial optical mode distribution based on a challenge C and outputting a changed optical mode distribution, the photonic PUF device including:
optical modes (Mᵢ) (e.g., optical mode waveguides for forming or supporting optical modes (Mᵢ)) to which the initial optical mode distribution is provided and from which the changed optical mode distribution is produced;
optical mode mixing layers (Kⱼ) spaced apart along, and coupled to, the optical modes (e.g., optical mode waveguides for forming or supporting optical modes (Mᵢ)) to mix the optical modes (Mᵢ) received by each optical mode mixing layer (Kⱼ) so that the optical mode distribution leaving each optical mode mixing layer (Kⱼ) is different to the optical mode distribution received by each optical mode mixing layer (Kⱼ),
columns (Sₖ) of optical phase shifters spaced apart along, and coupled to, the optical modes (e.g., optical mode waveguides for forming or supporting optical modes (Mᵢ)) for applying pre-determined optical phase shift(s) to change the respective phases of the optical modes (Mᵢ) prior to the optical modes (Mᵢ) being received by a respective optical mode mixing layer (Kⱼ);
a security controller for controlling the photonic PUF device and receiving the challenge C and providing a response R, wherein the security controller translates the challenge C and provides the translated challenge C to the photonic PUF device, and the security controller receives and translates a final optical mode distribution output by the photonic PUF device into the response R,
wherein the security controller is configured to operate the photonic PUF device to produce the final changed optical mode distribution by an iterative process including the following steps:
   a) the security controller uses the challenge C to set an initial optical mode distribution for processing by the PUF;
   b) the security controller obtains the amplitudes of the changed optical mode distribution;
   c) the security controller provides the amplitudes of the changed optical mode distribution to the PUF device to process as a further initial optical mode distribution; and
   d) the security controller iterates steps b) and c) T times to produce the final optical mode distribution.

Optionally or preferably, the security controller may be configured to change the settings of one or more or all of the optical phase shifters of the columns (Sₖ) of optical phase shifters as part of step c) so that the PUF device processes the further initial optical mode distribution based on the changed settings.

Optionally or preferably, the security controller uses the challenge C to set the settings of the columns (Sₖ) of optical phase shifters for each iteration of the process.

Optionally or preferably, the response R is translated only from the final optical mode distribution.

Optionally or preferably, the response R is translated from one or more or all of the changed optical mode distributions obtained at step b).

Optionally or preferably, the photonic PUF device includes a reconfigurable photonic network having an input (e.g., an input part) connectable to a single input optical mode (e.g., connectable to receive, form or support the single input optical mode), and output(s) (e.g., output parts) connectable to the optical modes (Mᵢ), wherein at step a), the security controller uses the challenge C to cause the reconfigurable photonic network to adopt a corresponding configuration in order to generate the initial optical mode distribution.

Optionally or preferably, step c) includes the security controller and uses the amplitudes of the changed optical mode distribution to cause the reconfigurable photonic network to adopt a corresponding configuration in order to generate, and provide, the amplitudes of the changed optical mode distribution to the PUF device.

Optionally or preferably, step c) includes the security controller transforming the changed optical mode distribution and providing the changed optical mode distribution to the PUF device to process as a further initial optical mode distribution.

Optionally or preferably, the security controller uses the transformed changed optical mode distribution to cause the reconfigurable photonic network to adopt a corresponding configuration in order to generate, and provide, the transformed changed optical mode distribution to the PUF device.

Optionally or preferably, the photonic PUF device includes an optical measurement device connected to the optical modes (Mᵢ) (e.g., connected to the optical mode waveguides) for measuring the changed and final optical mode distributions respectively.

According to an aspect of the present invention we provide a method or process for providing (e.g., of manufacturing) a system comprising a photonic physical unclonable function (PUF) device for receiving an initial optical mode distribution (e.g., associated with a challenge C) and outputting a final optical mode distribution (e.g., associated with a response R), and preferably further comprising information relating challenges C to respective responses R, the method including:
a) providing optical modes (Mᵢ) (e.g., optical mode waveguides for forming or supporting optical modes (Mᵢ)) to which the pre-determined initial optical mode distribution may be provided and from which the final optical mode distribution may be produced during use;
b) providing optical mixing layers (Kⱼ) spaced apart along, and coupled to, the optical modes (e.g., optical mode waveguides for forming or supporting optical modes (Mᵢ)) to mix the optical modes (Mᵢ) received by each optical mode mixing layer (Kⱼ) so that the optical mode distribution leaving each optical mode mixing layer (Kⱼ) is different to the optical mode distribution received by each optical mode mixing layer (Kⱼ);
c) forming optical coupling interfaces to the optical modes (e.g., optical mode waveguides for forming or supporting optical modes (Mᵢ)) that are coupled to the optical mode mixing layers (Kⱼ) at points prior to and after the respective ones of the optical mixing layers (Kⱼ);
d) conducting tomography through the optical coupling interfaces to determine the optical mode mixing operation of the optical mixing layers (Kⱼ) (e.g., that relates challenges C to respective responses R); and,
e) removing the optical coupling interfaces after step d) is completed.

Optionally or preferably, the method includes providing columns (Sₖ) of optical phase shifters spaced apart along, and coupled to, the optical modes (e.g., optical mode waveguides for forming or supporting optical modes (Mᵢ)) for applying pre-determined optical phase shift(s) to change the respective phases of the optical modes (Mᵢ) prior to the optical modes (Mᵢ) being received by a respective optical mode mixing layer, and wherein, at step c) the optical coupling interfaces are coupled at points after the respective preceding column (Sₖ) of optical shifters and/or coupled at points before the respective (subsequent) column (Sₖ+1) of optical shifters.

Optionally or preferably, step d) includes the tomography being conducted through each optical mode separately and/or on each optical mode mixing layer separately.

Optionally or preferably, step d) includes varying light input and/or the optical phase shifter settings of each optical mode entering the respective optical mode mixing layer during the tomography process and measuring the amplitude of the output light from each optical mode leaving the respective optical mode mixing layer. The determining of the mixing operation at step d) may comprise determining a unitary transformation of the optical modes that maps an input optical mode distribution to an outputted optical mode distribution from the respective optical mixing layers.

The method permits one to effectively determine the complete unitary for each optical mixing layer. The method may include parameterising the total unitary operation on the optical modes (Mᵢ) as the product of pairs of (characterised) optical mixing layers (Kⱼ) and column of optical phase shifters (Sₖ). The method may include determining the function that relates all challenges C to respective responses R. This allows the manufacturer of the PUF to learn the function that relates all challenges C to respective responses R, so that every possible CRP can be calculated by the manufacturer without probing the PUF. Afterwards, the ability to have optical access to the individual optical mode mixing layers (Kⱼ) to determine their unitary post-manufacture may be removed, i.e., the optical coupling interfaces are erased by physically and permanently modifying the PUF, i.e., the optical coupling interfaces, thereby removing access to this information by (non-authorised) third parties.

According to an aspect of the invention we provide a method of operating an apparatus or photonic PUF device of any preceding aspect including using the apparatus or photonic PUF device as part of an authentication process, optionally or preferably to authenticate a device, a user or a communication.

The optical modes disclosed herein, according to any aspect of the invention, may be formed in respective waveguides. The optical mode mixing layers (Kⱼ) disclosed above, according to any aspect of the invention, may include continuous evanescently coupled waveguides that receive at least a subset of the optical modes (Mᵢ) to effect mixing of optical modes. In examples, according to any aspect of the invention, the continuous evanescently coupled waveguides may correspond to regions of the waveguides within which the optical modes are formed. The evanescently coupled waveguides may implement the mixing of optical modes to provide a random walk of photons amongst/between the optical modes and/or amongst/between the evanescently coupled waveguides.

Different levels of randomness may be achieved according to the fabrication technology used to fabricate the waveguides. Randomness may be achieved according to microscopic features of the waveguides that are not (e.g., cannot be) pre-determinedly formed during manufacture, i.e., the microscopic features are out of the manufacturer's control. The waveguides may be fabricated according to one or more of the following methods: optical, projection and electron beam lithography, and etching. For example, a waveguide line edge roughness of about 6 nm (e.g., between about 3 nm and about 10 nm) may be provided.

Line edge roughness (LER) may be defined according to the normal definition in the industry whereby LER=3σ with σ being a standard deviation defined by:

$$σ = \sqrt{( \frac{1}{N} {\sum }_{i = 1}^{N} {( δ {x}_{i} )}^{2} )}$$

Here, δxᵢ=xᵢ−x̅, where xᵢ is a measured edge position at a given point i along the edge (i=1 to N), amongst N separate points along the edge, and x̅ is the average value of all of the N measured edge positions. All edge positions are measured relative to a common reference line (e.g., a notional ‘perfect’ edge position). The edge positions (xᵢ) for calculating an LER value are usually measured using images (or other data) generated by a Critical Dimension Scanning Electron Microscope (CD-SEM). Images (or other data) generated an Atomic Force Microscope (AFM) may give more precise values at bigger correlation lengths, but CD-SEM is a standard in the industry as it is faster. CD-SEM images may be processed with software to extract the required edge positions (xᵢ) for calculating an LER value, and one example is PROSEM (see https://prosem.genisys-gmbh.com/), which is a software package designed for this purpose and available from: GenlSys GmbH, Eschenstr. 66, D-82024 Taufkirchen (Munich), GERMANY.

The rough nature of the sidewalls (e.g., microscopic features) may provide desired levels of randomness. The design of the optical mode mixing layer, including waveguide dimension, separation and length, may be optimized to achieve sufficient variation between different layers within a PUF device and between successive PUF devices/copies, during manufacture.

In examples of the technology, according to any aspect of the invention, the separation between the evanescently coupled waveguides and/or length over which the evanescently coupled waveguides are proximate to one another may be pre-determinedly formed so that the strength of evanescent coupling in the respective optical mode mixing layers (Kⱼ) is determined by a combination of this separation and length.

A transverse distance (i.e., “s”, a separation transverse to a waveguide axis) may be provided between neighbouring or adjacent waveguides. The transverse distance may differ between neighbouring or adjacent waveguides so that the separation distance between adjacent waveguides is greater for certain neighbouring or adjacent waveguides or less for certain other neighbouring or adjacent waveguides.

In examples, two or more separation distances “s” may be the same. The distance “I” denotes the longitudinal length over which the waveguides are coupled. The degree of coupling can be adjusted by changing the values of one or more of the parameters “s”, and “l”.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a schematic diagram of an apparatus embodying the present disclosure;

FIG. 2 is a schematic diagram of components of an apparatus embodying the present disclosure;

FIG. 3 is a schematic diagram of components of an apparatus embodying the present disclosure;

FIGS. 4A and 4B show certain components of an apparatus embodying the present disclosure;

FIGS. 5A and 5B are schematic diagrams illustrating certain parts of an apparatus embodying the present disclosure;

FIG. 6 is a schematic diagram showing certain components of a device embodying certain aspects of the present disclosure;

FIG. 7 is a flow diagram showing a certain methodology for operating a device embodying certain aspects of the present disclosure; and

FIG. 8 is a flow diagram showing a certain methodology for manufacturing a device embodying certain aspects of the present disclosure.

### DETAILED DESCRIPTION OF THE DISCLOSURE

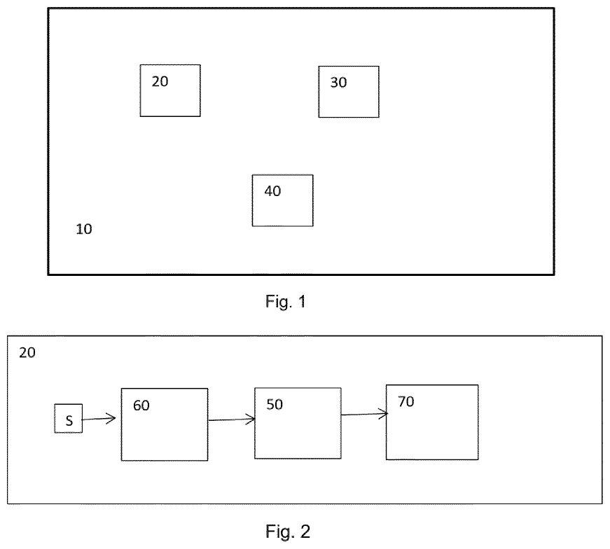

With reference to FIG. 1, this schematically shows an apparatus 10 including a photonic physically unclonable function (PUF) device 20; a security controller 30 for controlling the PUF device 20 and a computer readable storage medium 40 including instructions for a processor to operate the security controller 30. In embodiments of the technology, the apparatus 10 may be integrated or form part of an apparatus, e.g., as part of a mobile phone, computer or other electronic or non-electronic device, for use as part of an authentication operation of the apparatus. In embodiments of the technology, the apparatus 10 may be connected to another apparatus, e.g., an electronic device, for use therewith to conduct an authentication operation. The processor may be formed as part of the apparatus 10 or form part of the apparatus in which it is incorporated or connected to.

With reference to FIG. 2, this schematically shows a PUF device 20 in accordance with examples of the technology. The PUF device 20 may be realised as a classical device, i.e., dealing with classical light (e.g., laser light), or realised as a quantum device, i.e., dealing with light as a quantum state. The PUF device 20 may include a photonic processing network 50, a reconfigurable photonic network 60, and an optical measurement device 70. The term photonic processing network denotes an optical interferometer circuit which is part of the broader optical interferometer which forms the PUF device 20. In examples of the technology, the PUF device 20 is an integrated photonic chip. The photonic chip may be formed in materials including but not limited to Silicon (Si), Silicon nitride (SiN), Silica (SiO₂), Gallium Arsenide (GaAs), Indium Phosphide (InP), Polymer, Lithium Niobate (LiNbO) or Aluminium Nitride (AlN).

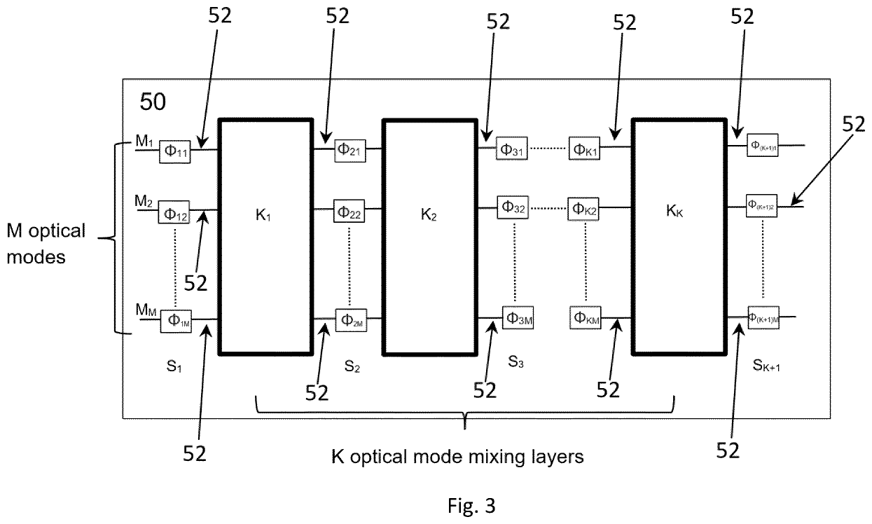

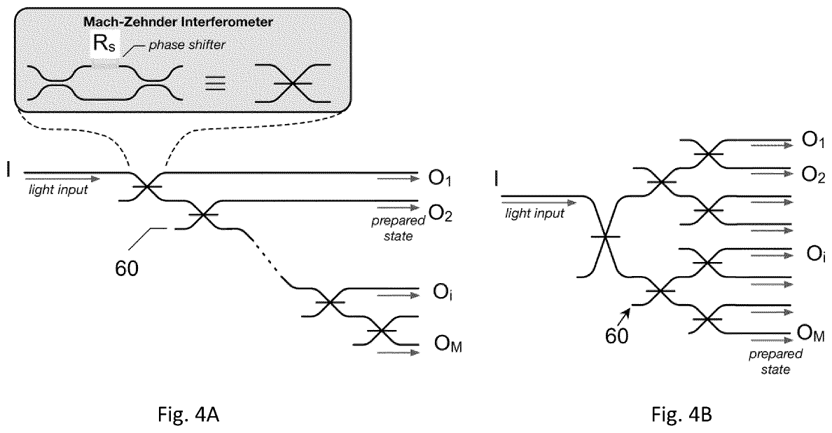

With reference to FIG. 3, the PUF device 20 is for processing an initial optical mode distribution as part of a challenge C and outputting a final optical mode distribution, corresponding to a response R or from which a response R can be derived. With reference to FIG. 3, the photonic processing network 50 may include an M number of optical modes (Mᵢ) to which the initial optical mode distribution is provided and from which the final optical mode distribution is produced. The photonic processing network 50 may include a K number of optical mode mixing layers (Kⱼ) spaced apart along, and coupled to, the optical modes (Mᵢ) to mix the optical modes (Mᵢ) received by each optical mode mixing layer (Kⱼ) so that the optical mode distribution leaving each optical mode mixing layer (Kⱼ) is distributed differently to the optical mode distribution received by each optical mode mixing layer (Kⱼ). In examples, the final optical mode distribution is the optical mode distribution after the final optical mode mixing layer (Kk; where j=K), i.e., the optical mode distribution after the last optical mode mixing layer has operated on the optical modes (Mᵢ).

In examples of the technology, the optical modes (Mᵢ) are formed or supported in respective waveguides (i.e., the Mᵢ may be considered to refer to waveguides 52, where i=1 to M; e.g., M≥3, or M≥5, or M≥10), the optical mode mixing layers (Kⱼ) may include continuous evanescently coupled waveguides that receive at least a subset of the optical modes (Mᵢ) to effect mixing of those M optical modes. Examples of suitable continuous evanescently coupled waveguides for use with the present examples of this disclosure include the random walk described in Paesani et al. Nature Physics 15, 925 (2019). The Mᵢ optical modes may be formed in respective Mᵢ waveguides (i.e., the Mᵢ may be considered to refer to waveguides 52, where i=1 to M). In examples, the continuous evanescently coupled waveguides may correspond to regions of the waveguides (Mᵢ).

In examples of the technology, the separation between the evanescently coupled waveguides and/or length over which the evanescently coupled waveguides are proximate to one another is pre-determinedly formed so that the strength of evanescent coupling in the respective optical mode mixing layers (Kⱼ) is determined by a combination of this separation and length, and microscopic features of the waveguides that cannot be pre-determinedly formed during manufacture, i.e. the microscopic features are out of the manufacturer's control.

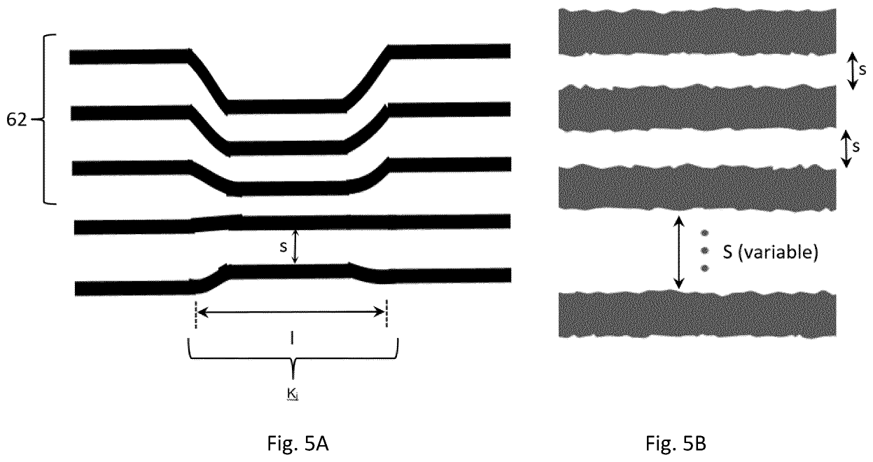

With reference to FIGS. 5A and 5B, FIG. 5A shows an optical mode mixing layer for which the optical modes (Mᵢ) are formed in waveguides that are continuous evanescently coupled. The distance “s” denotes the respective transverse distance between neighbouring or adjacent waveguides (see FIG. 5B). In examples, the transverse distance “s” may differ between neighbouring or adjacent waveguides so that the separation distance “s” is greater for certain neighbouring or adjacent waveguides or less for certain other neighbouring or adjacent waveguides. In examples, two or more separation distances “s” may be the same. The distance “I” denotes the longitudinal length over which the waveguides are coupled. The degree of coupling can be adjusted by changing one or more of the parameters “s”, and “I”.

The photonic processing network 50 may include columns (Sₖ) of optical phase shifters Cji spaced apart along, and coupled to, the optical modes (Mᵢ) within the waveguides 52 for applying optical phase shift(s), determined by, or derived from the challenge C, to change the respective phases of the optical modes (Mᵢ) prior to the optical modes being received by a respective optical mode mixing layer (Kⱼ, where j denotes the next adjacent optical mode mixing layer and i denotes the optical mode/waveguide (Mᵢ) to which it is coupled). In examples, the optical phase shifters qji; may be coupled to each of the optical modes for each respective column (Sₖ), or a subset of them. Similarly, in examples, there may be fewer columns such that between adjacent optical mode mixing layers there is no column of optical phase shifters. The optical phase shifters @ji are devices which may be independently controllable to induce optical phase shifts. For example, the optical phase shifts may be implemented as local refractive index changes induced by effects including, but not limited to, thermo-optic, electro-optic, carrier-injection, piezo-electric, birefringent, micro-electro-mechanical, strain-inducing, or acousto-optic.

According to examples of the technology, the columns (Sₖ) of optical phase shifters may be alternately arranged with respect to the optical mode mixing layers (Kⱼ) along the length of the optical modes/waveguides (Mᵢ). In embodiments according to examples of the technology, j=1 to K, i.e. there are a total of K optical mode mixing layers, and k=1 to K+1, i.e. there are a total of K+1 columns of optical phase shifters, such that the S_{K}+1 column of optical phase shifters may, in examples, apply an adjustment of the final optical mode distribution in the optical modes (Mᵢ) for use in downstream interferometry. In examples, there may be only k=1 to K columns of optical phase shifters and there is no SK+1 column of optical phase shifters.

In embodiments according to examples of the technology, for two, or more, or each, of the columns (Sₖ) of optical phase shifters, the optical phase shifters (ji are coupled to each one of the optical modes/waveguides (Mᵢ). In embodiments according to examples of the technology, one, or more, or each, of the optical mode mixing layers (Kⱼ) mixes at least three or all of the optical modes (Mᵢ) e.g., mixing the respective amplitudes of the at least three or all of the optical modes (Mᵢ). The mixing here refers to the light in the at least three of the optical modes (Mᵢ) being mixed between the said at least three optical modes, e.g., between at least three neighbouring or adjacent optical modes (Mᵢ). In embodiments according to examples of the technology, for each of the columns (Sₖ) of optical phase shifters, the optical phase shifters (Dji are each coupled to one of the optical modes/waveguides (Mᵢ) and each of the optical mode mixing layers mixes (Kⱼ), three or more or all of the optical modes, Mᵢ (as shown in FIG. 3). In examples for which the optical mode mixing layers are continuous evanescently coupled waveguides, three or more, or all of the waveguides in which the optical modes (Mᵢ) are formed, are coupled.

In examples, one or more or all of the optical mode mixing layers (Kⱼ) include continuous evanescently coupled waveguides that receive at least three or all of the optical modes (Mᵢ) to effect mixing of the respective amplitudes of the at least three or all of the optical modes (Mᵢ).

References herein to “at least three” in the context of at least three optical modes (Mᵢ), and/or of at least three evanescently coupled waveguides, may include, for example: four or more optical modes (Mᵢ), and/or four or more evanescently coupled waveguides; five or more optical modes (Mᵢ), and/or five or more evanescently coupled waveguides; ten or more optical modes (Mᵢ), and/or ten or more evanescently coupled waveguides; ten or more optical modes (Mᵢ), and/or ten or more evanescently coupled waveguides. The evanescently coupled waveguides may implement the mixing of optical modes to provide a random walk of photons amongst/between the optical modes and/or amongst/between the evanescently coupled waveguides, as noted above, and this effect has been found to be significantly enhanced as the number of modes and/or waveguides involved in the mixing process increases above two.

The processor is configured to carry out instructions on the computer readable storage medium 40 to issue a challenge C to the security controller 30 and receive a response R from the security controller 30 as will be explained.

The security controller 30 translates the challenge C and provides the translated challenge C to the PUF device 20, and the security controller receives and translates a final optical mode distribution output by the PUF device 20 into the response R.

The security controller 30 for operating the PUF can be realised via a standard digital electronics microcontroller, or field programmable gate array (FPGA) that can be packaged alongside or directly co-integrated alongside the integrated photonics chip in which the PUF device 20 is formed. The challenge C is received by the security controller 30 through a wireless transmission (e.g., RF wave, optical wave) or a wired connection (e.g. digital line formed by DC electronics. Each optical phase shifter @ji may be programmable by an n-bit number corresponding to 2″ discrete values. In embodiments, the challenge C received by security controller 30 may be provided as a bit string from which the optical phase shifter settings may be derived, as will be described below. In example embodiments, the security controller 30 for operating the PUF may be realised using on-chip electronic logic. In such examples, the security controller 30 may receive a challenge C (e.g., from a computer processer) as an input bit string which may be processed by the security controller 30 to apply bit shifting and/or masking to map the input bit string with a one-to-one correspondence to the phase shifter settings. Prior to mapping, the input bit string may be digitally processed (e.g., via a hashing function) by the security controller 30 to improve randomness between challenges that are separated by a small Hamming distance. In examples, the on-chip electronic logic may include digital-to-analogue converters with voltage, current regulators and amplifiers that can process the challenge C and convert it to a set of voltages for operating the respective phase shifters to effect operation with the desired phase shifter settings corresponding to the challenge C. The digital-to-analogue converters may be electrically connected to the phase shifters to implement the desired operation.

With reference to FIGS. 4A and 4B in particular, the reconfigurable photonic network 60 may include an input connectable to a single input optical mode I, and outputs Oi connectable to the optical modes/waveguides (Mᵢ) to provide, respectively, the initial optical mode input and output distribution thereto. The reconfigurable photonic network 60 may include optical phase shifters (Rₛ) for generating the initial optical mode distribution. The reconfigurable photonic network 60 may include a linear series of Mach-Zehnder interferometers (shown in FIG. 4A), a universal input interferometer in a triangular or rectangular arrangement (not shown), or a binary tree arrangement of Mach-Zehnder interferometers (shown in FIG. 4B). The reconfigurable photonic network 60 prepares a state, i.e., the initial distribution of amplitudes over optical modes, for processing by the photonic processing network 50. The reconfigurable photonic network 60, e.g., in the case of a linear series of Mach-Zehnder interferometers, may transform light from the single input optical mode I into a linear optical state that spans all of the optical modes (Mᵢ) so that any desired initial optical mode distribution may be obtained by transforming one optical mode into all of the required optical modes (Mᵢ). In examples, the security controller 30 may use optical mode distribution information, e.g., a measured optical mode distribution output from the photonic processing network 50 to cause the reconfigurable photonic circuit to adopt a corresponding configuration in order to generate a new initial optical mode distribution.

The PUF device 20 may include a light source S (see FIG. 2) from which the initial optical mode distribution is created. Where provided, the light source may be connected to the single input optical mode I of the reconfigurable photonic network 60, or directly to the optical mode waveguides 52 (Mᵢ) of the PUF device 20. The light source may include a laser, e.g., an electrically pumped integrated laser, an LED source with a narrow light spectrum, or a quantum state of light, e.g., squeezed light or single photons. In examples of the technology, the initial optical mode distribution may be provided in a form ready for distribution over the optical modes and/or optical mode waveguides 52 (Mᵢ), for example, over spectral modes in a fibre/broadband network rather than having a single input optical mode from which the distribution is generated through the use of the reconfigurable photonic network 60.

Optical measurement device 70 may be connected to the optical modes (i.e., waveguides 52 which form or support the modes) for measuring the final optical mode distribution of the optical modes formed therein (Mᵢ). Optical measurement device 70 may include photodiodes or single photon detectors, or superconducting nanowires, transition edge sensors, avalanche photodiodes or homodyne detection schemes for examples in which the PUF is realised as a quantum device.

In example embodiments of the PUF including on-chip electronic logic and the PUF including integrated photodetectors as the optical measurement device 70, the photocurrent from the photodetectors may be amplified and changed to a digital signal through analogue-to-digital converters.

The apparatus 10 may be fabricated using known techniques in relation to integrated photonic devices albeit without their employment to create an apparatus 10 having the described structure in relation to examples of the technology.

Operation of the apparatus 10 according to examples of the technology to obtain challenge-response pairs will now be described.

A set of challenges C′ is created, with each unique challenge denoted C. The processor may create the challenges C′ randomly in the form of bit strings. Each challenge C may include the initial optical mode distribution information, e.g. in the form of optical phase shifter settings information to set the Rₛ optical phase shifters, and/or settings to set the columns (Sₖ) of optical phase shifters. The optical phase shifter settings information may be directly obtained from the bit string which forms the challenge C or it may be indirectly obtained/derived, e.g. converted therefrom, by employing a hash function or other algorithm. The security controller 30, on being issued a challenge C from the processor, may be configured to determine the optical phase shifter settings from the bit string which forms the challenge C.

In examples, the challenge C may be a concatenated bit string of length n (KM+I), where I is the number of Rₛ optical phase shifters which distribute light among the optical modes (Mᵢ) to create the initial optical mode distribution, n is the phase shifter bit-resolution of the Rₛ and Pji phase shifters, and K is the number of optical phase shifter columns such that the bit string represents the total number of programmable phase shifters multiplied by the n-bit phase shifter resolution. Alternatively, in examples, a different length bit string may be issued as the challenge C and the security controller 30 includes a way to map the received challenge C to the phase shifter settings of the PUF device 20. The challenge may be processed with digital-to-analogue converters to define on-chip voltages (i.e., phases) set on the optical chip modulators of the phase shifters.

For each challenge C, the security controller 30 sets the columns (Sₖ) of optical phase shifters and the Rₛ optical phase shifters. The reconfigurable photonic network 60 then, configured to these settings, produces the initial optical mode distribution which is provided to the optical modes (i.e., to the waveguides 52 which form or support the modes) of the photonic processing network 50. The initial optical mode distribution is changed, due to the optical phase shifts, under the operation of the first column (S₁) of the optical phase shifters before being transformed under the mixing which occurs between the optical modes (Mᵢ) due to the first optical mode mixing layer coupling (K₁) at least a subset of the optical modes (Mᵢ) together so the optical mode distribution leaving the first optical mode mixing layer (K₁) is differently distributed. This sequence is continued until the light has travelled to the end of the photonic processing network 50. The final optical mode distribution is output by the photonic processing network 50 and measured by the optical measurement device 70. The final optical mode distribution, as measured by device 70, may then be translated, e.g., digitised, into a response R in a form including but not restricted to a bit string by the security controller 30 and provided to the processor. In examples, the response R may be further processed by electronic (analogue or digital) functions, e.g., a hashing function, to increase the random nature and/or security of the PUF.

In examples, the response R may correspond to results from optical intensities/amplitudes (or correlated photon measurements) read out by photodiodes (or devices sensitive to quantum states where the PUF is realised as a quantum system, e.g., single photon detectors) where so used as the optical measurement device 70. In the case of optical intensities/amplitudes, the security controller 30 may take photocurrents through the use of analogue-to-digital converters which digitise the output, or may take calibrated power measurements that are passed to the security controller 30 in digital form. The security controller 30 may receive the M output intensities from the optical modes (Mᵢ) and discretise these into 2m levels (i.e., an m-bit number). Subsequent digital post-processing of the concatenated bit strings from each photodiode readout may be performed via methods including, but not limited to, hashing or exclusive-OR (XOR) operations on equal length subdivisions of the full response bit-string. Finally, the digital response bit string may be returned from the security controller 30 via a wireless or wired connection.

The process is repeated for each challenge C for the set of challenges C′ to create a set of challenge response pairs CRP′.

The apparatus 10 may now be integrated or connected to another apparatus for use by a trusted client A. The apparatus 10 is then supplied securely to client A, by a trusted method, together with the set of challenge response pairs CRP′.

Client A may then subsequently provide the apparatus 10 to a client B. If client A wishes to authenticate the identity of client B, client A may issue a challenge C from the original set of challenges C′ to client B. Client B must then obtain a response R and communicate this to client A. If the response R matches that held in the corresponding challenge out of the original set of challenge response pairs CRP′, then trust has been established.

Alternatively, the fabricator or manufacturer may create the apparatus 10 and provide it to client A. Client A subsequently obtains the set of challenge response pairs CRP′ in the same way described above prior to providing the apparatus 10 to client B. Authentication of client B to establish a secure connection can then proceed in the same way for each communication between the client A and client B.

Due to the arrangement of the PUF device utilising an interleaved arrangement of columns of optical phase shifters and optical mode mixing layers, an exponentially large number of possible challenge response pairs can be obtained and this number varies in a non-linear way when the number of optical mode mixing layers is increased. Further to this, even if two PUF devices according to examples of this technology were fabricated to identical fabrication methods, the physical realisation of the PUF devices would still be unique and mutually distinct. This is because of the microscopic features of the waveguides that form the optical mode mixing layers, such as the roughness of the walls of the waveguides, which cannot be pre-determinedly formed during manufacture (i.e., which are beyond the manufacturer's control). The features will affect the phase and coupling strength between waveguides, and, allied to this, the mixing characteristics for each optical mode mixing layer. The degree of randomness so introduced can be advantageously accentuated by increasing the length over which the waveguides are proximate one another and/or the separation distance between the waveguides. The optical mode mixing layers are effectively random unitary transformations which act on the optical mode distributions they each receive.

Different levels of randomness can be achieved depending on the fabrication technology used, including optical, projection and electron beam lithography, and the etch used to define the waveguide layer. For example, dry projection lithography can achieve a distribution of the target waveguide dimension with sigma ˜1 nm, and line edge roughness of ˜6 nm. FIG. 5B shows waveguides having been so produced. The rough nature of the sidewalls is visible therein. The design of the optical mode mixing layer, including waveguide dimension, separation and length, is optimized to achieve sufficient variation between different layers and PUF copies.

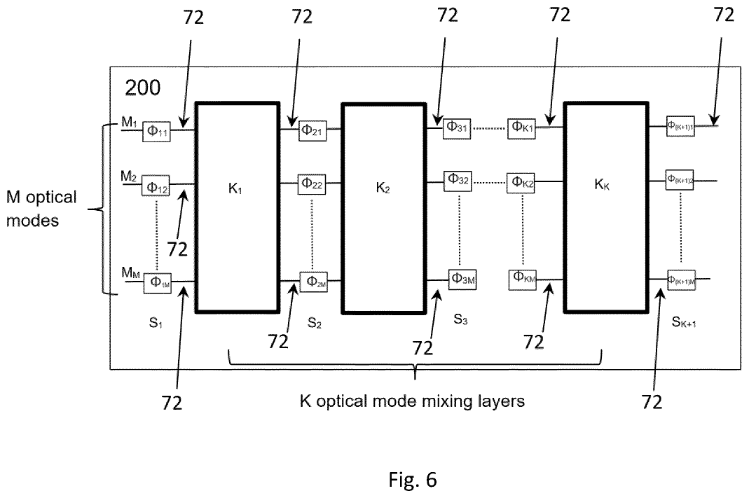

Examples of a further aspect according to the technology will now be described with reference to FIG. 6.

FIG. 6 schematically illustrates a photonic physically unclonable function (PUF) device 200. PUF device 200 may be interchangeable with the photonic processing network 50 of the previously described PUF device 20.

PUF device 200 is for processing an initial optical mode distribution that may be partly based on a challenge C and outputting a changed optical mode distribution. The PUF device 200 includes optical modes (Mᵢ, M in total) to which the initial optical mode distribution is provided and from which the changed optical mode distribution is produced. The PUF device 200 includes optical mode mixing layers (Kⱼ) spaced apart along, and coupled to, the optical modes (i.e., coupled to the optical mode waveguides 72 for forming or supporting optical modes) to mix the optical modes (Mᵢ) received by each optical mode mixing layer (Kⱼ) so that the optical mode distribution leaving each optical mode mixing layer (Kⱼ) is different to the optical mode distribution received by each optical mode mixing layer (Kⱼ). The PUF device 200 includes columns (Sₖ) of optical phase shifters spaced apart along, and coupled to, the optical mode waveguides 72 for applying optical phase shift(s) to the optical modes (Mᵢ) formed or supported therein e.g., derived from the challenge C in similar ways to those described previously, to change the respective phases of the optical modes (Mᵢ) prior to the optical modes being received by a respective optical mode mixing layer (Kᵢ). The PUF device 200 may include a security controller for controlling the photonic PUF device 200. The security controller may translate a challenge C and provide the translated challenge C to the photonic PUF device 200 and translate a final changed optical mode distribution output by the photonic PUF device 200 into a response R.

The optical mode mixing layers (Kⱼ), the optical modes (Mᵢ) and optical mode waveguides 72 for forming or supporting optical modes, and the columns (Sₖ) of optical phase shifters may be the same or similar to those described in relation to previous embodiments of the present technology. In embodiments of the present technology, the optical mode mixing layers may be configured differently, for example, each optical mode mixing layer may include a number of Mach-Zehnder interferometers configured to mix light travelling between pairs of Mᵢ optical modes prior to the light reaching the next column of optical phase shifters.

The PUF device 200 may include one or more elements, e.g., the optical measurement device, light source, in the same or similar way to the PUF device 20 described in relation to previous examples of the technology.

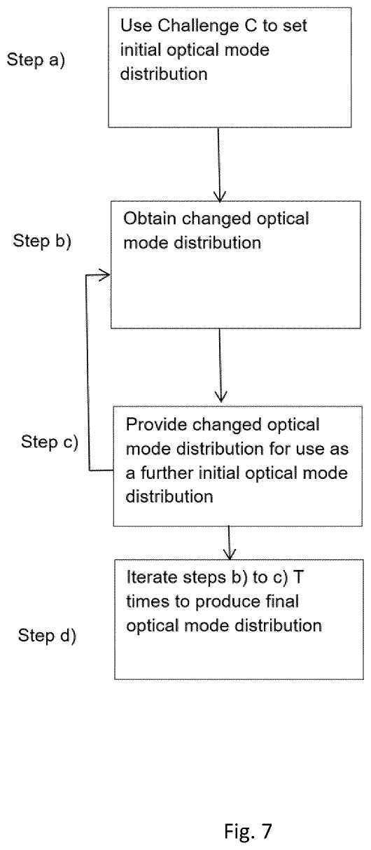

The main difference between the PUF device 200 and that described in relation to previous embodiments is that the security controller is configured to operate the photonic PUF device 200 to produce the final changed optical mode distribution by an iterative process as shown in FIG. 7.

The iterative process includes a first step a) in which the challenge C is used to set an initial optical mode distribution for processing by the PUF device 200, and challenge C is also used to set the optical phase shifters within the PUF device 200. At step b) the security controller obtains the changed optical mode distribution output by the PUF device 200. At step c) the security controller provides the amplitudes of the changed optical mode distribution to the PUF device 200, e.g. through a feedback circuit or the use of a security controller, to process as a further initial optical mode distribution, e.g. the security controller may use the received amplitudes from step c) to derive optical phase shifter settings for setting a reconfigurable switch network to create the desired further initial optical mode distribution, or to derive new phase shifter settings in the PUF device 200, or to derive both. Steps b) to c) are then repeated T times to produce the final optical mode distribution.

Operation of the PUF device 200 is similar to that described in relation to the photonic processing network 50 other than the security controller operates the PUF device 200 in an iterative way to obtain the final optical mode distribution and that the security controller may be configured to change the settings of one or more or all of the optical phase shifters of the columns (Sₖ) as part of step c) so that the PUF device processes the further initial optical mode distribution based on the changed settings. The settings of the columns (Sₖ) of optical phase shifters for each iteration of the process may be obtained from the challenge C in examples. The response R for a particular challenge C may correspond to the translated version of the final optical mode distribution. In examples, the response R may be translated from one or more or all of the changed optical mode distributions obtained at step b). In examples, a function may be applied to each changed optical mode distribution to generate the further initial optical mode distribution to be used in the next iteration.

In examples, the security controller may, at step c), transform the changed optical mode distribution and provide the transformed changed optical mode distribution to the PUF device to process as a further initial optical mode distribution. In examples, where the PUF device includes on-chip electronic logic, the transformation of the changed optical mode distribution may include applying cryptographic logical operations by converting the changed optical mode distribution into a digital measurement through analogue-to-digital converters coupled to the detectors of the optical measurement device 70. This further amplifies randomness to prior to the transformed changed optical mode distribution being processed as a further initial optical mode distribution. The phase-shifter settings are updated accordingly for subsequent operation of the PUF device a desired number of T times until the final optical mode distribution is obtained.

PUF device 200 is advantageous in that the number of available challenges and associated responses can be increased by simply increasing the number of iterations without having to create a larger PUF device.

In examples according to the technology, the PUF device 200 may include a reconfigurable photonic network similar to the reconfigurable photonic network 60 having an input connectable to a single input optical mode, and output(s) connectable to the Mᵢ optical modes, wherein at step a), the security controller uses the challenge C to cause the reconfigurable photonic network to adopt a corresponding configuration in order to generate the initial optical mode distribution. The security controller may also, in examples, at step c) be configured to use the changed optical mode distribution to cause the reconfigurable photonic network to adopt a corresponding configuration in order to generate, and provide, the changed optical mode distribution to the PUF device. For example, the security controller may obtain measurements of the changed optical mode distribution, e.g., where the PUF device 200 or an apparatus it is part of includes an optical measurement device similar to optical measurement device 70, and be configured to calculate the optical phase shifter settings of the reconfigurable photonic network required for it to generate the further initial optical mode distribution based on the changed optical mode distribution. Similarly, for embodiments of the technology in which the security controller transforms the changed optical mode distribution and provides the transformed changed optical mode distribution to the PUF device 200, the security controller may be configured to calculate the required optical phase shifter settings for the reconfigurable photonic network to generate the further initial optical mode distribution based on the transformed changed optical mode distribution.

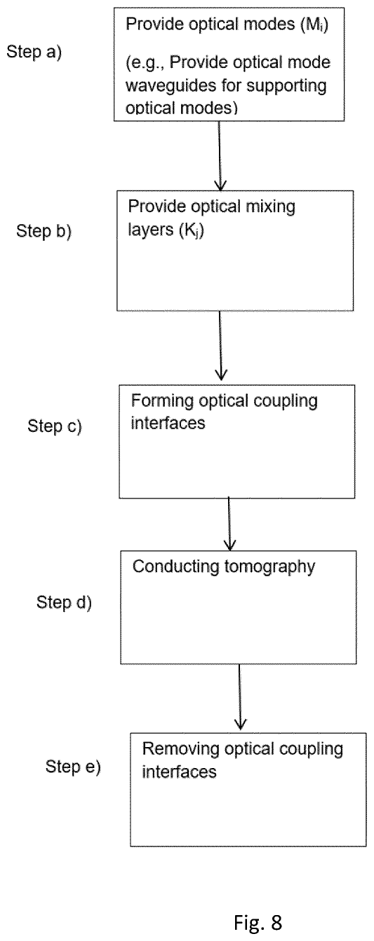

According to an aspect of the present technology, a method of manufacturing a physical unclonable function (PUF) will be described with reference to FIG. 8. The PUF is formed as a photonic chip.

The method includes at a step a) providing optical modes (Mᵢ) (i.e., optical mode waveguides for forming or supporting optical modes) to which the pre-determined initial optical mode distribution may be provided and from which the final optical mode distribution may be produced during use. Step b) includes providing optical mode mixing layers (Kⱼ) spaced apart along, and coupled to, the optical modes (i.e., optical mode waveguides for forming or supporting optical modes) to mix the optical modes (Mᵢ) received by each optical mode mixing layer (Kⱼ) so that the optical mode distribution leaving each optical mode mixing layer (Kⱼ) is different to the optical mode distribution received by each optical mode mixing layer (Kⱼ). Step c) includes forming optical coupling interfaces to the optical modes/waveguides (Mᵢ) that are coupled to the optical mode mixing layers (Kⱼ) at points prior to and after the respective ones of the optical mixing layers (Kⱼ). Step d) includes conducting tomography through the optical coupling interfaces to determine the optical mode mixing operation (e.g., to determine the unitary transformation of the optical modes that maps an input optical mode distribution to an outputted optical mode distribution from the respective optical mixing layers) of the optical mixing layers (Kⱼ). Step e) includes removing the optical coupling interfaces after step d) is completed to complete the PUF.

In examples, the method may include providing columns (Sₖ) of optical phase shifters spaced apart along, and coupled to, the optical modes (i.e., optical mode waveguides for forming or supporting optical modes) for applying pre-determined optical phase shift(s) to change the respective phases of the optical modes (Mᵢ) prior to the optical modes being received by a respective optical mode mixing layer (Kⱼ), and at step c) of the optical coupling interfaces being coupled at points after the respective preceding column (Sₖ) of optical phase shifters and/or coupled at points before the respective (subsequent) column (Sₖ₊₁) of optical phase shifters.

The present method permits one to effectively determine the complete unitary for each optical mixing layer. In more detail, the total unitary operation on the optical modes (Mᵢ) can be parameterised as the product of pairs of (characterised) optical mixing layers (Kⱼ) and column of optical phase shifters (Sₖ). This allows the manufacturer of the PUF to learn the function that relates all challenges C to respective responses R, so that every possible CRP can be calculated by the manufacturer without probing the PUF. Afterwards, the ability to have optical access to the individual optical mode mixing layers (Kⱼ) to determine their unitary post-manufacture is removed, i.e., the optical coupling interfaces are erased by physically and permanently modifying the PUF, i.e. the optical coupling interfaces, thereby removing access to this information by (non-authorised) third parties.

The optical coupling interfaces may be different devices or components that can be subsequently removed at step e). For example, the optical coupling interfaces may include grating couplers, which apply periodic perturbation of the refractive index to scatter light out of the plane of the PUF, or a beam splitter optical tap with high reflectivity to couple light into and out of the PUF, or integrated photodiodes.

The tomography at step d) includes tomographic tasks being conducted on each Mᵢ optical mode separately and/or each optical mode mixing layer (Kⱼ) separately. Step d) may include varying light input and/or the optical phase shifter settings of each optical mode entering the respective optical mode mixing layer during the tomography process and measuring the amplitude of the output light from each optical mode leaving the respective optical mode mixing layer. An example of a tomography technique that can be used at step d) can be found in Optics Express, Vol. 21, Issue 11, pp. 13450-13458 (2013) authored by Saleh Rahimi-Keshari, Matthew A. Broome, Robert Fickler, Alessandro Fedrizzi, Timothy C. Ralph, and Andrew G. White. For an ensemble of light input states for each of the Mᵢ optical modes, the intensities/amplitudes of light output from the respective Kⱼ optical mixing layer are recorded. By use of reconstruction (e.g., PhaseLift—an example of this technique is described in arXiv: 2010.00517 [Physics. Optics] authored by Daniel Suess, Nicola Maraviglia, Richard Kueng, Alexandre Maïnos, Chris Sparrow, Toshikazu Hashimoto, Nobuyuki Matsuda, David Gross, and Anthony Laing), the transformation unitary matrix of the respective Kⱼ optical mixing layer is learned. This process is repeated for each Kⱼ optical mixing layer, thereby allowing the manufacturer to reconstruct the total parameterised unitary transformation and learn the underlying function mapping all challenges C to responses R.

After full tomography of the PUF device is completed at step d), the optical coupling interfaces are destroyed via physical or chemical post-processing. For example, a grating coupler, where used as part of the optical coupling interfaces, could be exposed to ultra-high intensity pulsed laser radiation to damage the component such that the optical coupler no longer diffracts lights and the input/readout mechanism is terminated. Alternatively, modification of the optical coupling interfaces can be realised via bombardment with focused ion beams, electron beam lithography, chemical etching of the structure through oxide windows, or thermal annealing and out-diffusion of implanted ion dopant optical couplers (see, by way of example, “Erasable ion implanted optical couplers”, WO2011142913A3). Furthermore, readout photodiodes, if employed, could be rendered ineffective via electrostatic discharge, or biasing (forward or reverse) beyond the electronic damage threshold.

It will be readily appreciated that the present method according to the examples described is advantageous in that it allows the manufacturer to have all the CRP information without having to probe the PUF device post manufacture.

The present method according to the examples described can be adopted for different PUF device architectures for which the tomography of the device is important for the purpose of deriving CRP information, and which may have sequential constructions in terms of how they operate on inputted light to obtain a response. The present method can be used in relation to any of the PUF devices described in the present application, but also to other PUF devices as well without departing from the scope of the present invention.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described. Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps. It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

### REFERENCES

Paesani et al.: Nature Physics 15, 925 (2019).
Saleh Rahimi-Keshari, Matthew A. Broome, Robert Fickler, Alessandro Fedrizzi, Timothy C. Ralph, and Andrew G. White: Optics Express, Vol. 21, Issue 11, pp. 13450-13458 (2013).
Daniel Suess, Nicola Maraviglia, Richard Kueng, Alexandre Maïnos, Chris Sparrow, Toshikazu Hashimoto, Nobuyuki Matsuda, David Gross, and Anthony Laing: arXiv: 2010.00517 [Physics. Optics].

### WO2011142913A3

1. An apparatus including:
a photonic physically unclonable function (PUF) device for processing an initial optical mode distribution based on a challenge C and outputting a final optical mode distribution, the photonic PUF device including:
optical mode waveguides for forming or supporting optical modes (Mᵢ) to which the initial optical mode distribution is provided and from which the final optical mode distribution is produced;
optical mode mixing layers (Kⱼ) spaced apart along, and coupled to, the Mᵢ optical mode waveguides to mix the Mᵢ optical modes received by each optical mode mixing layer (Kⱼ) so that the optical mode distribution leaving each optical mode mixing layer (Kⱼ) is different to the optical mode distribution received by each optical mode mixing layer (Kⱼ);
columns (Sₖ) of optical phase shifters spaced apart along, and coupled to, the optical mode waveguides for applying pre-determined optical phase shift(s) to change the respective phases of the optical modes (Mᵢ) prior to the optical modes being received by a respective optical mode mixing layer (Kⱼ), wherein, for two, or more, or each, of the columns (Sₖ) of optical phase shifters, the optical phase shifters are coupled to each one of the optical mode waveguides;
a security controller for controlling the photonic PUF device and receiving the challenge C and providing a response R, wherein the security controller translates the challenge C and provides the translated challenge C to the photonic PUF device, and the security controller receives and translates a final optical mode distribution output by the photonic PUF device into the response R;
a computer readable storage medium including instructions for a processor to:
issue a challenge C to the security controller; and
receive a response R from the security controller.

2. An apparatus including:
a photonic physically unclonable function (PUF) device for processing an initial optical mode distribution based on a challenge C and outputting a final optical mode distribution, the photonic PUF device including:
optical mode waveguides for forming or supporting optical modes (Mᵢ) to which the initial optical mode distribution is provided and from which the final optical mode distribution is produced;
optical mode mixing layers (Kⱼ) spaced apart along, and coupled to, the optical mode waveguides to mix the optical modes (Mᵢ) received by each Kⱼ optical mode mixing layer so that the optical mode distribution leaving each mixing layer is different to the optical mode distribution received by each optical mode mixing layer (Kⱼ), wherein one, or more, or each, of the optical mode mixing layers (Kⱼ) mixes more than two of optical modes (Mᵢ);
columns (Sₖ) of optical phase shifters spaced apart along, and coupled to, the optical mode waveguides for applying pre-determined optical phase shift(s) to change the respective phases of the optical modes (Mᵢ) prior to the optical modes being received by a respective optical mode mixing layer (Kⱼ);
a security controller for controlling the photonic PUF device and receiving the challenge C and providing a response R, wherein the security controller translates the challenge C and provides the translated challenge C to the photonic PUF device, and the security controller receives and translates a final optical mode distribution output by the photonic PUF device into the response R;
a computer readable storage medium including instructions for a processor to:
issue a challenge C to the security controller; and
receive a response R from the security controller.

3. An apparatus to claim 2, wherein, for two, or more, or each, of the columns (Sₖ) of optical phase shifters, the optical phase shifters are coupled to each one of the optical mode waveguides, and/or wherein one, or more, or each, of the optical mode mixing layers (Kⱼ) mixes all of the optical modes (Mᵢ).

4. An apparatus according to claim 1, 2 or 3 including a reconfigurable photonic network having an input part connectable to support or form a single input optical mode, and an output(s) part(s) connectable to the optical mode waveguides, wherein the challenge C includes initial optical mode distribution information and the security controller uses the initial optical mode distribution information to cause the reconfigurable photonic circuit to adopt a corresponding configuration in order to generate the initial optical mode distribution.

5. An apparatus according to claim 4 wherein the reconfigurable photonic network includes optical phase shifters (Rₛ) for generating the initial optical mode distribution.

6. An apparatus according to claim 4 or 5 wherein the reconfigurable photonic network comprises an array of Mach-Zehnder interferometers for transforming light from the single input optical mode into an optical state corresponding to the initial optical mode distribution over the optical modes (Mᵢ).

7. An apparatus according to any preceding claim including one or more of:
a) wherein the challenge C includes information to determine the optical phase shifter settings, and the security controller uses this information that determines the optical phase shifter settings to set the columns (Sₖ) of optical phase shifters and/or, when dependent directly or indirectly on claim 4, to set the optical phase shifters (Rₛ);
b) wherein the columns (Sₖ) of optical phase shifters and the optical mode mixing layers (Kⱼ) alternate along the length of the optical mode waveguides; and
c) wherein j=0 to K, and k=0 to K+1, wherein the (S_{K+1})^{th} column of optical phase shifters is for applying an adjustment of the final optical mode distribution in the optical modes (Mᵢ) for subsequent use downstream in an interferometer process.

8. A photonic physically unclonable function (PUF) device for processing an initial optical mode distribution based on a challenge C and outputting a final optical mode distribution, the photonic PUF device including:
optical mode waveguides for forming or supporting optical modes (Mᵢ) to which the initial optical mode distribution is provided and from which the final optical mode distribution is produced;
optical mode mixing layers (Kⱼ) spaced apart along, and coupled to, the optical mode waveguides to mix the optical modes (Mᵢ) received by each optical mode mixing layer (Kⱼ) so that the optical mode distribution leaving each optical mode mixing layer (Kⱼ) is distributed differently to the optical mode distribution received by each optical mode mixing layer (Kⱼ), wherein each of the optical mode mixing layers (Kⱼ) include continuous evanescently coupled waveguides that receive at least a subset of the optical modes (Mᵢ) to effect mixing of the respective amplitudes of the subset of the optical modes (Mᵢ);
columns of optical phase shifters (Sₖ) spaced apart along, and coupled to, the optical mode waveguides for applying pre-determined optical phase shift(s) to change the respective phases of the optical modes (Mᵢ) prior to the optical modes being received by a respective optical mode mixing layer (Kⱼ); and
a security controller for controlling the photonic PUF device and receiving the challenge C and providing a response R, wherein the security controller translates the challenge C and provides the translated challenge C to the photonic PUF device, and the security controller receives and translates a final optical mode distribution output by the photonic PUF device into the response R; and
a computer readable storage medium including instructions for a processor to:
issue a challenge C to the security controller; and
receive a response R from the security controller.

9. A photonic physically unclonable function (PUF) according to claim 8 wherein the optical modes (Mᵢ) are formed in respective optical mode waveguides, and the continuous evanescently coupled waveguides correspond to regions of the optical mode waveguides.

10. An apparatus according to any one of claims 1 to 7, wherein each of the optical mode mixing layers (Kⱼ) include continuous evanescently coupled waveguides that receive at least a subset of the optical modes (Mᵢ) to effect mixing of the respective amplitudes of the subset of the optical modes (Mᵢ), optionally or preferably the optical modes (Mᵢ) are formed in respective optical mode waveguides, and the continuous evanescently coupled waveguides correspond to regions of the optical mode waveguides.

11. An apparatus or photonic physically unclonable function (PUF) according to claim 8, 9 or 10 wherein a separation between the evanescently coupled waveguides and/or length over which the evanescently coupled waveguides are proximate to one another is pre-determinedly formed so that the strength of evanescent coupling of the respective optical mode mixing layers (Kⱼ) is determined by a combination of the separation and length, and microscopic features of the waveguides that are not pre-determinedly formed during manufacture.

12. An apparatus or photonic physically unclonable function (PUF) according to any one of claims 8 to 11 wherein one or more of the optical mode mixing layers (Kⱼ) include continuous evanescently coupled waveguides that receive at least three, or all, of the optical modes (Mᵢ) to effect mixing of the respective amplitudes of the at least three, or all, of the Mᵢ optical modes.

13. An apparatus or photonic physically unclonable function (PUF) according to any preceding claim including a light source from which the initial optical mode distribution is created, wherein the light source includes one or more of: a laser, an electrically pumped integrated laser, an LED source (e.g., with a narrow light spectrum), a quantum state of light, (e.g., squeezed light or single photons).

14. An apparatus or photonic physically unclonable function (PUF) according to any preceding claim including one or more of:
a) an optical measurement device connected to the optical mode waveguides for measuring the final optical mode distribution, optionally or preferably the optical measurement device includes photodiodes or single photon detectors;
b) the photonic physically unclonable function (PUF) comprises an integrated photonic chip; optionally the integrated photonic chip is formed from one or more of Silicon (Si), Silicon nitride (SiN), Silica (SiO₂), Gallium Arsenide (GaAs), Indium Phosphide (InP), Polymer, Lithium Niobate (LiNbO), or Aluminium Nitride (AlN); and
c) the optical phase shifters are independently controllable and/or may include thermo-optic, electro-optic, piezo-electric, birefringent, micro-electro-mechanical, strain-inducing, or acousto-optic devices.

15. A photonic physically unclonable function (PUF) device for processing an initial optical mode distribution based on a challenge C and outputting a changed optical mode distribution, the photonic PUF device including:
optical mode waveguides for forming or supporting optical modes (Mᵢ) to which the initial optical mode distribution is provided and from which the changed optical mode distribution is produced;
optical mode mixing layers (Kⱼ) spaced apart along, and coupled to, the optical mode waveguides to mix the optical modes (Mᵢ) received by each optical mode mixing layer (Kⱼ) so that the optical mode distribution leaving each optical mode mixing layer (Kⱼ) is different to the optical mode distribution received by each optical mode mixing layer (Kⱼ),
columns (Sₖ) of optical phase shifters spaced apart along, and coupled to, the optical mode waveguides for applying pre-determined optical phase shift(s) to change the respective phases of the optical modes (Mᵢ) prior to the optical modes being received by a respective optical mode mixing layer (Kⱼ);
a security controller for controlling the photonic PUF device and receiving the challenge C and providing a response R, wherein the security controller translates the challenge C and provides the translated challenge C to the photonic PUF device, and the security controller receives and translates a final optical mode distribution output by the photonic PUF device into the response R, wherein the security controller is configured to operate the photonic PUF device to produce the final changed optical mode distribution by an iterative process including the following steps:
a) the security controller uses the challenge C to set an initial optical mode distribution for processing by the PUF;
b) the security controller obtains the amplitudes of the changed optical mode distribution;
c) the security controller provides the amplitudes of the changed optical mode distribution to the PUF device to process as a further initial optical mode distribution; and
d) the security controller iterates steps b) and c) T times to produce the final optical mode distribution.

16. A photonic PUF device according to claim 15, wherein the security controller may be configured to change the settings of one or more or all of the optical phase shifters of the columns of optical phase shifters (Sₖ) as part of step c) so that the PUF device processes the further initial optical mode distribution based on the changed settings.

17. A photonic PUF device according to claim 16, wherein the security controller uses the challenge C to set the settings of the columns (Sₖ) of optical phase shifters for each iteration of the process.

18. A photonic PUF device according to claim 15, 16 or 17 wherein the response R is translated only from the final optical mode distribution.

19. A photonic PUF device according to claim 15, 16, 17 or 18 wherein the response R is translated from one or more or all of the changed optical mode distributions obtained at step b).

20. A photonic PUF device according to any one of claims 15 to 19, including a reconfigurable photonic network having an input part connectable to support or form a single input optical mode, and an output(s) part(s) connectable to the optical mode waveguides, wherein at step a), the security controller uses the challenge C to cause the reconfigurable photonic network to adopt a corresponding configuration in order to generate the initial optical mode distribution.

21. A photonic PUF device according to claim 20, wherein, step c) includes the security controller and uses the amplitudes of the changed optical mode distribution to cause the reconfigurable photonic network to adopt a corresponding configuration in order to generate, and provide, the amplitudes of the changed optical mode distribution to the PUF device.

22. A photonic PUF device according to any one of claims 15 to 21, wherein, step c) includes the security controller transforming the changed optical mode distribution and providing the changed optical mode distribution to the PUF device to process as a further initial optical mode distribution.

23. A photonic PUF device according to claim 22 when dependent on claim 21, wherein the security controller uses the transformed changed optical mode distribution to cause the reconfigurable photonic network to adopt a corresponding configuration in order to generate, and provide, the transformed changed optical mode distribution to the PUF device.

24. A photonic PUF device according to any one of claims 15 to 23 including an optical measurement device connected to the optical mode waveguides for measuring the changed and final optical mode distributions respectively.

25. A method of providing a system comprising a photonic physical unclonable function (PUF) device for receiving an initial optical mode distribution associated with a challenge C and outputting a final optical mode distribution associated with a response R, and information relating challenges C to respective responses R, the method including:
a) providing optical mode waveguides for forming or supporting optical modes (Mᵢ) to which the pre-determined initial optical mode distribution may be provided and from which the final optical mode distribution may be produced during use;
b) providing optical mixing layers (Kⱼ) spaced apart along, and coupled to, the optical mode waveguides to mix the optical modes (Mᵢ) received by each optical mode mixing layer (Kⱼ) so that the optical mode distribution leaving each optical mode mixing layer (Kⱼ) is different to the optical mode distribution received by each Kⱼ optical mode mixing layer;
c) forming optical coupling interfaces to the optical mode waveguides that are coupled to the optical mode mixing layers (Kⱼ) at points prior to and after the respective ones of the optical mixing layers (Kⱼ);
d) conducting tomography through the optical coupling interfaces to determine the optical mode mixing operation of the optical mixing layers (Kⱼ) that relates challenges C to respective responses R; and
e) removing the optical coupling interfaces after step d) is completed.

26. A method according to claim 25, including providing columns (Sₖ) of optical phase shifters spaced apart along, and coupled to, the optical mode waveguides for applying pre-determined optical phase shift(s) to change the respective phases of the optical modes (Mᵢ) prior to the optical modes (Mᵢ) being received by a respective optical mode mixing layer (Kⱼ), and wherein, at step c) the optical coupling interfaces are coupled at points after the respective preceding column (Sₖ) of optical shifters and/or coupled at points before the respective (subsequent) column (Sₖ₊₁) of optical shifters.

27. A method according to claim 25 or 26 wherein step d) includes the tomography being conducted through each optical mode separately and/or on each optical mode mixing layer separately and/or wherein step d) includes varying light input and/or the optical phase shifter settings of each optical mode entering the respective optical mode mixing layer during the tomography process and measuring the amplitude of the output light from each optical mode leaving the respective optical mode mixing layer.

28. A method of operating an apparatus or photonic PUF device of any one of claims 1 to 24 including using the apparatus or photonic PUF device as part of an authentication process, optionally or preferably to authenticate a device, a user or a communication.
